(19) United States
(12) Patent Application Publication
(10) Pub. No.: US 2026/0320371 A1
(43) Pub. Date: Oct. 15, 2026

(54) A METHOD FOR ACCELERATING NUMERICAL SOLUTION TO MULTIPHASE WELLBORE FLOW USING ARTIFICIAL INTELLIGENCE

(71) Applicant: SAUDI ARABIAN OIL COMPANY, Dhahran (SA)

(72) Inventors: Anton Gryzlov, Moscow (RU); Sergey Safonov, Moscow (RU); Muhammad Arsalan, Dhahran (SA)

(73) Assignee: Aramco Innovations LLC, Moscow (RU)

(21) Appl. No.: 18/835,895

(22) PCT Filed: Nov. 15, 2023
(86) PCT No.: PCT/RU2023/000347

§ 371 Date: Aug. 5, 2024

(51) Int. Cl. G06N 3/08; G06N 3/0442

(52) U.S. Cl. CPC G06N 3/08; G06N 3/0442

(57) ABSTRACT

A method for solving a multiphase fluid flow model with an iterative sol ve that is initialized using artificial intelligence. The method includes obtaining a set of equations, the set of equations including at least one equation, and the set of equations modeling a flow of a multiphase fluid, where the flow is characterized by a set of flow variables. The method further includes determining, with an artificial intelligence model, a predicted set of flow variables at a timestep given one or more prior sets of flow variables each previously determined at an associated prior timestep, and determining, with an iterative solver applied to the set of equations, the set of flow variables at the timestep, where the iterative solver is initialized with the predicted set of flow variables at the timestep.

### BACKGROUND

Multiphase fluid flows in wellbores can be modeled by various, complex fluid dynamics systems of equations. As an example, tri-phase drift-flux systems model the displacement of water, oil and gas simultaneously, with a partial differential equation modeling the conservation of momentum of the mixture as a whole.

Systems of equations modeling multiphase flows are usually non-linear. Consequently, many iterative numerical methods approximating these systems, such as implicit time-marching numerical schemes, involve solving a non-linear system of equations at each iteration. Solving such a non-linear system of equations is usually computationally intensive and performed by using an iterative solver, such as a Newton method.

The convergence and speed of convergence of iterative solvers are never guaranteed, and often depend on the suitable choice of an initial guess of their solution. A poor choice of an initial guess can lead the iterative solver to diverge or being prohibitively slow.

### SUMMARY

Embodiments disclosed herein generally relate to a method for solving a multiphase fluid flow model with an iterative solver that is initialized using artificial intelligence. The method includes obtaining a set of equations including at least one equation, the set of equations modeling a flow of a multiphase fluid, where the flow is characterized by a set of flow variables. The method further includes determining, with an artificial intelligence model, a predicted set of flow variables at a timestep given one or more prior sets of flow variables each previously determined at an associated prior timestep, and determining, with an iterative solver applied to the set of equations, the set of flow variables at the timestep, where the iterative solver is initialized with the predicted set of flow variables at the timestep.

Embodiments disclosed herein generally relate to a system for solving a multiphase fluid flow model with an iterative solver that is initialized using artificial intelligence. The system includes a pipe that conveys a flow of a multiphase fluid, the flow characterized by a set of flow variables. The system further includes a data acquisition system that collects a set of measured flow variables at one or more locations within the pipe, from a plurality of sensors disposed on the pipe, and a computer with one or more computer processors, the computer communicatively connected to the data acquisition system. The computer is configured to receive a set of flow variables at a set of one or more timesteps, obtain a set of equations including at least one equation, the set of equations modeling the flow of the multiphase fluid in the pipe. The computer is further configured to determine, with an artificial intelligence model, a predicted set of flow variables at a timestep posterior to set of one or more timesteps, given the set of flow variables at the set of one or more timesteps, and determine, with an iterative solver applied to the set of equations, the set of flow variables at the timestep, the iterative solver initialized with the predicted set of flow variables at the timestep and informed by the set of measured flow variables at one or more locations within the pipe.

Embodiments disclosed herein generally relate to a non-transitory computer-readable memory for solving a multiphase fluid flow model with an iterative solver that is initialized using artificial intelligence. The non-transitory computer-readable memory includes computer-executable instructions stored thereon that, when executed on a processor, cause the processor to perform steps, including obtaining a set of equations of at least one equation, the set of equations modeling a flow of a multiphase fluid, where the flow is characterized by a set of flow variables. The steps further include determining, with an artificial intelligence model, a predicted set of flow variables at a timestep given one or more prior sets of flow variables each previously determined at an associated prior timestep, and determining, with an iterative solver applied to the set of equations, the set of flow variables at the timestep, the iterative solver initialized with the predicted set of flow variables at the timestep.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 depicts an example of a pipe that conveys a flow of a multiphase fluid, in accordance with one or more embodiments.

FIG. 2 depicts a flowchart of a method for predicting the value of some multiphase fluid flow variables, in accordance with one or more embodiments.

FIG. 3 depicts schematic representation of a Newton method for solving a non-linear equation, in accordance with one or more embodiments.

FIG. 4 depicts a numerical method, in accordance with one or more embodiments.

FIG. 5A depicts an example of a discretization of a time interval, in accordance with one or more embodiments.

FIG. 5B depicts an example of a discretization of a time interval, in accordance with one or more embodiments.

FIG. 6 depicts an example of a spatial discretization of a pipe, in accordance with one or more embodiments.

FIG. 7 depicts a description of the mechanics of running an AI model, in accordance with one or more embodiments.

FIG. 8 depicts an example diagram of a neural network, in accordance with one or more embodiments.

FIG. 9 depicts an example of a hydrocarbon production well site, in accordance with one or more embodiments.

FIG. 10 depicts a block diagram with an example of a hydrocarbon production well and a fluid flow simulator, in accordance with one or more embodiments.

FIG. 11 depicts a system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. For example, a temperature sensor may reference two or more such temperature sensors.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowchart may be omitted, repeated, and/or performed in a different order than the order shown. Accordingly, the scope disclosed herein should not be considered limited to the specific arrangement of steps shown in the flowchart.

Although multiple dependent claims are not introduced, it would be apparent to one of ordinary skill that the subject matter of the dependent claims of one or more embodiments may be combined with other dependent claims.

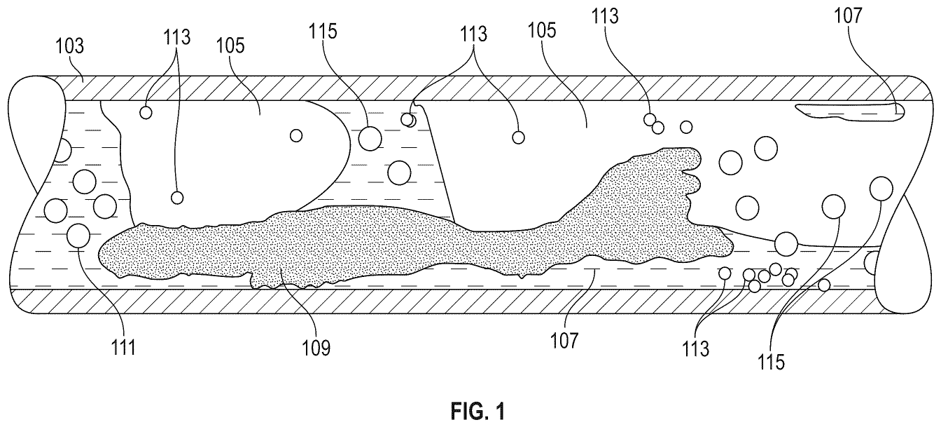

In the following description of FIGS. 1-11, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

FIG. 1 depicts a simplified view of a cross-section of a pipe (103), carrying a multiphase fluid. Examples of pipes where a multiphase fluid may flow include a wellbore of a hydrocarbon production well and a pipeline. As seen, the multiphase fluid may have multiple constituents such as gas (105), water (107), and oil (109). A multiphase fluid flow for a fluid with three principal phases is referred to herein as a tri-phase fluid flow. Additional constituents such as solid contaminants may be present in the tri-phase flow, where the flow is still considered tri-phase given that additional constituents are not considered principal phases. The various constituents of the multiphase fluid may be distributed within the pipe (103) in a myriad of ways. As a non-limiting example, gas (105) may be enclosed by liquids (water or oil) forming bubbles (111). Or, in contrast, liquid droplets, such as oil droplets (113) and water droplets (115), may be dispersed in the gas (105) to form a mist. In general, the state of the multiphase fluid may be described using broad classifications. That is, the multiphase fluid may be categorized as “bubbly,” “annular,” “churn,” “mist,” “stratified,” or other designations (flow classes) based on the distribution of the constituents and their relative quantities. The state of the multiphase fluid may be transient such that any assignment of flow class may change with time. The multiphase fluid is characterized by a set of flow variables. Examples of flow variables within the set of flow variables may include a density for each phase, a fluid velocity for each phase, a pressure for each phase, and a volume fraction of the total fluid volume for each phase. Other examples of flow variables may include a pressure of the multiphase fluid and the velocity of the liquid phase. For the tri-phase flow represented in FIG. 1, the liquid phase includes the water (107) and oil (109) but excludes the gas (105).

Embodiments disclosed herein generally relate to a method for accelerating an iterative solution of a set of equations modeling a flow of a multiphase fluid, such as that depicted in FIG. 1. In general, the convergence and speed of convergence of iterative solvers, e.g., applied to the set of equations, depend on an initial guess, or an initial state (e.g., a defined set of flow variables), provided to the iterative solver. As such, in one or more embodiments, an initial guess is determined using an artificial intelligence (AI) model such that a number of iterations required to achieve convergence is reduced when compared to an application of the iterative solver given an initial guess not determined by the artificial intelligence model. In one or more embodiments, the artificial intelligence model is trained using data produced by the iterative solver modeling the flow over an initial number of timesteps.

In general, a mathematical formulation representative of the flow of a multiphase fluid can be formulated and consists of a set of partial differential equations (or, more simply, a “set of equations”). Typically, the set of equations describe the conservation of mass, momentum, and energy of the multiphase fluid through a volume confined by the geometry of the pipe (or other conduit) that convey the multiphase flude. Often, the set of equations are discretized over some volume encompassing the multiphase fluid (e.g., a section of pipe) into a finite number of grid blocks representing. Then, the discretized set of equations is solved numerically using an appropriate mathematical method, for example, employing an iterative solver.

As an example, the set of equations modeling the flow of the multiphase fluid can be described as an isothermal, compressible, three-phase drift-flux system. In this system, the velocity of one phase is expressed with respect to the other phases. An example of a spatially one-dimensional, isothermal, compressible, three-phase drift-flux system, where the three phases are water, oil, and gas, is given by the following set of equations:

$$\frac{\partial }{\partial t} ( {α}_{g} {ρ}_{g} ) + \frac{\partial }{\partial x} ( {α}_{g} {ρ}_{g} {v}_{g} ) = {q}_{g} , \qquad EQ 1$$

$$\frac{\partial }{\partial t} ( {α}_{w} {ρ}_{w} ) + \frac{\partial }{\partial x} ( {α}_{w} {ρ}_{w} {v}_{w} ) = {q}_{w} , \qquad EQ 2$$

$$\frac{\partial }{\partial t} ( {α}_{o} {ρ}_{o} ) + \frac{\partial }{\partial x} ( {α}_{o} {ρ}_{o} {v}_{o} ) = {q}_{o} , \qquad EQ 3$$

$$\frac{\partial {v}_{m}}{\partial t} + {v}_{m} \frac{\partial {v}_{m}}{\partial x} = - \frac{1}{{ρ}_{m}} \frac{\partial p}{\partial x} - g cos θ - \frac{2 f {v}_{m} \vert {v}_{m} \vert}{D} , \qquad EQ 4$$

$${α}_{g} + {α}_{l} = 1 , \qquad EQ 5$$

$${α}_{l} = {α}_{o} + {α}_{w} , \qquad EQ 6$$

$${ρ}_{j} = {ρ}_{i} ( p ) for i = g , w , o , \qquad EQ 7$$

$${v}_{m} = {α}_{g} {v}_{g} + {α}_{l} {v}_{l} , \qquad EQ 8$$

$${ρ}_{m} = {α}_{g} {ρ}_{g} + {α}_{l} {ρ}_{l} , \qquad EQ 9$$

$${v}_{g} = {C}_{0} {v}_{m} + {v}_{d θ} , \qquad EQ 10$$

$${v}_{0} = {C}_{0}^{′} {v}_{l} + {v}_{d θ}^{′} , \qquad EQ 11$$

$${v}_{l} = \frac{{α}_{0} {v}_{0} + {α}_{w} {v}_{w}}{{α}_{l}} , and \qquad EQ 12$$

$${ρ}_{l} = \frac{{α}_{o} {ρ}_{o} + {α}_{w} {ρ}_{w}}{{α}_{l}} . \qquad EQ 13$$

In this set of equations, x denotes a one-dimensional spatial coordinate, t indicates time or a temporal coordinate, and the subscripts g, w, and o indicate the phases of gas, water, and oil, respectively. Further, αₖ is the volume fraction of the k^{th} phase, ρₖ is the density of the k^{th} phase, υₖ is the velocity of the k^{th} phase, for k=g,w,o. The quantity p represents pressure, g is the gravitational constant, θ is the pipe inclination angle with respect to an upward vertical, qₖ represents a mass source for the k^{th} phase and D is the pipe diameter. Equations EQ 1, EQ2 and EQ3 represent the conservation of mass for each phase. A distinguishing feature of the isothermal, compressible, three-phase drift-flux model is that it treats the multiphase fluid as a whole, single mixture, rather than three separate phases, in the momentum equation EQ 4. In EQ 8, υₘ denotes a mixture (or bulk) velocity and ρₘ, defined in EQ 9, denotes a mixture (or bulk) density. The function ƒ=ƒ(α_{g},υₘ,p) is a friction coefficient depending on the gas volume fraction, mixture velocity and pressure. Equations EQ 5 and EQ 6 relate the volume fractions of the oil, water, and gas phases. Equation EQ 7 expresses the dependence of the density on the pressure, for each phase. Equations EQ 10 and EQ 11 are drift-flux formulas, which relate the velocity of the gaseous phase to the velocity of the mixture, and the velocity of the oil phase to the velocity of the liquid phases. Each of the equations EQ 10 and EQ 11 includes two empirical parameters, namely, C₀,υ_{dθ} for EQ 10 and

$${C}_{0}^{′} , {v}_{d θ}^{′}$$

for EQ 11. Finally, equations EQ 12 and EQ 13 define the velocity, υₗ and the density, ρₗ of the liquid phase, as a combination of the oil and water phases. In the system of equations EQ 1-EQ 13, the fluid flow variables are the pressure p and the αₖ, υₖ, υₖ, for k=g,w,o.

The formulation of the drift-flux model in equation EQ 1-EQ 13 is isothermal, which means that the temperature variations are neglected. However, EQ 1-EQ 13 may be extended, by means of supplemental energy conservation equations, to thermal drift-flux models, in which the temperature variations are not neglected, and in which case the flow variables may include a temperature of the multiphase fluid. Further, in the system of equations EQ 1-EQ 13, the use of one spatial dimension, rather than three spatial dimensions, reflects an assumption that the pipe's length-to-diameter aspect ratio is large, so that the diameter of the pipe is considered negligeable compared to its length. Such an assumption, that the diameter of the pipe is negligeable compared to its length, may be made, for example, when the pipe represents a wellbore or a pipeline. Nevertheless, the physics occurring in the other two spatial dimensions are taken into account with the diameter D in equation EQ 4. It is further emphasized that the one-dimensional drift-flux system of equations EQ 1-EQ 13 is given only as an example of a model describing a multiphase fluid flow and should not be considered limiting. One with ordinary skill in the art will recognize that the scope of this disclosure extends to any multiphase fluid flow model, with any number of spatial dimensions, including 2 or more spatial dimensions.

Introducing a time index, t, an iterative solver may seek to solve for a state-vector, U, at a timestep t, i.e., U^{t}, given, at least, one or more state-vectors at prior timesteps where the one or more prior state-vectors may be used to initialize an iterative solver. For example, consider the case where the time integration scheme of the discretized set of equations (e.g., equations EQ 1-13) are solved using Newton's method at a timestep (t+1). Newton's method is an iterative solver that aims at solving for U^{t+1} an equation of the form F(U^{t+1})=0, where F is a non-linear function, and U^{t+1} is a vector of unknown variables selected in such a way that the vector contains all the independent variables of the governing system (i.e., modeled flow) on the entire operational interval. Note that a more detailed description of Newton's method is provided later in the instant disclosure, however, for now it is sufficient to state that F represents some function resulting from the discretization of the set of equations used to model the flow and U is the state-vector that includes all of the dynamic variables in each discrete grid block. For example, using the set of equations for an isothermal, compressible, tri-phase drift-flux system, as described above, the state vector includes the mixture velocity, Um, the volume fraction of gas, α_{g}, the volume fraction of oil, αₒ, and the pressure, p, at each grid block where these variables are unknown (i.e., may exclude grid blocks equipped with sensor providing, for example, boundary conditions). That is, in this example, U^{t+1}=[υₘ, α_{g}, α₀,p]^{t+1}. Introducing an iteration index, k, the solution, based on Newton's method is determined by iteratively updating the state-vector U, at a given timestep, say timestep t+1, U^{k,t+1}, with δU^{k,t+1} where δU^{k,t+1} is determined from J^{k,t+1}·δU^{k,t+1}=−F(U^{k,t+1}), where J is the Jacobian matrix. That is, U^{k+1,t+1}=U^{k,t+1}+δU^{k,t+1}, where this process is applied iteratively until meeting some termination criterion such as the value of k reaching a number of maximum iterations or some measure of δU^{k,t+1} (e.g., root mean square over the elements of δU^{k,t+1}) becoming small or less than some convergence threshold (i.e., convergence). Note that because the iterative solver is applied at a given timestep, the superscript representing the timestep can be dropped. That is, the above expressions can be written as J^{k}·δU^{k}=−F(U^{k}) and U^{k+1}=U^{k}+δU^{k} without ambiguity. However, the timestep superscript is retained here to make the following point. The iterative solver requires an initial state-vector to begin the iterative process, i.e., when solving for U^{t+1} an initial value for U^{t+1}, say when k=0, U^{k=0,t+1}, must be provided. Generally, U^{k=0,t+1} is set to the state-vector known at the prior timestep, i.e., U^{t}. In other words, an iterative solver operating to solve for U^{t+1} may be initialized with U^{t}, or U^{k=0,t+1}=U^{t}. Other initialization schemes exist, such a arbitrary assignment.

A previously discussed, the convergence and speed of convergence of iterative solvers, e.g., applied to the set of equations, depends on the initial state-vector provided to the iterative solver. Hereafter, the state-vector will be referred to as a set of flow variables, where the flow of a multiphase fluid is characterized by, at least, the set of flow variables. In accordance with one or more embodiments, an artificial intelligence (AI) model is developed and used to predict an initial set of flow variables to be used by an iterative solver. Thus, when using the AI model, the iterative solver is not, at a given timestep, initialized with a past set of flow variables (i.e., the state vector at the prior timestep) or initialized by some other means (e.g., uniform assignment). Further, the iterative solver requires less iterations to achieve convergence when using the initial set of flow variables determined using the artificial intelligence (AI) model. Thus, the AI model greatly reduces the computational requirement, in both time and cost, to model the flow of a multiphase fluid by reducing the number of iterations required to determine the set of flow variables at a given timestep.

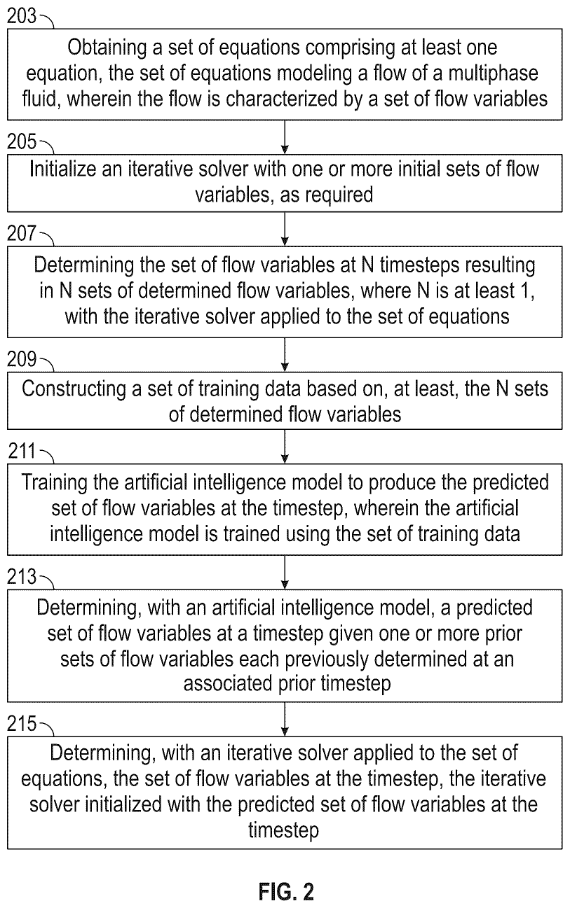

FIG. 2 depicts a flowchart demonstrating the development and use of an AI model to provide an initial set of flow variables to an iterative solver, the iterative solver being used to determine the set of flow variables at a given timestep while modeling the flow of a multiphase fluid, in accordance with one or more embodiments. In Block 203, a set of equations that models a flow of a multiphase fluid is obtained. The set of questions includes at least one equation (i.e., the set is non-zero). The flow is characterized by a set flow variables (i.e., a state-vector). Examples of sets of equations modeling a multiphase fluid flow include partial differential equations, such as the Navier-Stokes equations, which account for conservation of mass, conservation of momentum, and conservation of energy of the fluid flow. In some embodiments, the Navier-Stokes equations include a set of flow-dependent closure terms. Several variations may exist for a given system of equations modeling a fluid flow, such as the Navier-Stokes equations, accounting for whether the fluid is compressible, incompressible, steady-state, transient, laminar or turbulent, etc. In one or more embodiments, the set of equations is the isothermal, compressible, tri-phase drift-flux system previously described and the multiphase fluid consists of the phases of oil, gas, and water.

In accordance with one or more embodiments, the artificial intelligence (AI) model used to predict an initial set of flow variables to be used by an iterative solver must be developed. As will be shown, in FIG. 2, Blocks 205 to 211 deal with developing the AI model. Thus, in one or more embodiments, once the AI model is developed, or in circumstances where a previously developed AI model is employed (e.g., through a previous application of Blocks 203 to 211 on another, but similar, flow of a multiphase fluid), Blocks 203 to 211 may be skipped or otherwise omitted.

In one or more embodiments, at a first timestep, say t=1, an AI model may not yet have been developed. Thus, at this timestep and all subsequent timesteps until the AI model is developed, the iterative solver is initialized using one or more initial sets of flow variables, as required by the iterative solver, as depicted in Block 205. For example, for all timesteps evaluated without the AI model, the initial set of flow variables provided to the iterative solver at one of these given timesteps may be set to the set of flow variables determined by the iterative solver at the prior timestep (i.e., U^{k=0,t+1}=U^{t}). However, other methods for determining an initial set of flow variables for use by the iterative solver at a given timestep can be used, without limitation, until the AI model is developed. For example, for a timestep without the use of the AI model, the initial set of flow variables provided to the iterative solver may be obtained arbitrarily, or according to any specific prior experience. For example, in one or more embodiments, the initial set of flow variables (again, without the use of the AI model) is determined by measuring fluid properties at one or more locations in the flow that are interpolated and/or extrapolated to produce the initial set of flow variables. The measured fluid properties may be referred to as a set of measured flow variables, where the set of measured flow variables are measured and collected using one or more sensors, such as a temperature sensor, pressure sensor, or multiphase flow meter, coupled to a data acquisition system. Examples of extrapolation methods that may be used to extrapolate a set of measured flow variables to an initial set of fluid flow variables include interpolation methods such as a Lagrange interpolation method.

In Block 207, where, again, this block is only applied when developing the AI model, the flow of the multiphase fluid is modeled over N timesteps, where N is at least 1, with the iterative solver applied to the set of equations and initialized at each timestep with some set of initial flow variables as described in Block 205 (e.g., for a given timestep the set of initial flow variables is the set of flow variables from the prior timestep). So, assuming the first timestep is indexed as t=1 then the result of Block 207 is a determined set of flow variables at each timestep 1 through N, where each of the N sets of determined flow variables was determined using the iterative solver. Or, returning to the notation of the state-vector (i.e., set of flow variables), U, the result of Block 207 is the set of state-vectors {U^{t}} for i=1, . . . ,N.

In Block 207, a set of training data is constructed from the N sets of determined flow variables. The set of training data consists of one or more “training examples” where each training example is composed of an input-target pair. The training examples are structured according to the configuration of the AI model to be developed. In one or more embodiments, the AI model is configured to accept one or more sets of flow variables and predict another set of flow variables. For example, in one or more embodiments, for a given timestep t, the AI model is configured to receive, as an input, the sets of flow variables corresponding to the three previous timesteps (i.e., (t−1), (t−2), and (t−3)) and output the set of flow variables att (i.e., if the AI model is represented as a function G, then U^{t}=G(U^{t-1}, U^{t-2},U^{t-3})). In one or more embodiments, the AI model is configured to accept M contiguous sets of flow variables, where 1≤M<N and predict the set of flow variables at the next timestep. As an example, consider the case where N=1 and M=3, then the set of training data may be constructed as shown in Table I, where each training example represented according to the form (input, output).

TABLE I
Example set of training data constructed from 10 (N = 10) sets of
determined flow variables, a set of flow variables represented
as U to train an AI model configured to accept 3 (M = 3) sets
of flow variables, in accordance with one or more embodiments.
Training Examples

((U¹, U², U³), U⁴)
((U², U³, U⁴), U⁵)
((U³, U⁴, U⁵), U⁶)
((U⁴, U⁵, U⁶), U⁷)
((U⁵, U⁶, U⁷), U⁸)
((U⁶, U⁷, U⁸), U⁹)
((U⁷, U⁸, U⁹), U¹⁰)

In other embodiments, the AI model is configured to accept a variable number of inputs (i.e., sets of flow variables at prior timesteps), such as when the AI model is a recurrent neural network (RNN) (e.g., long short-term memory (LSTM) network) or transformer. In these cases, the set of training data may be constructed with training examples of different input structures (e.g., ((U¹, U²,U³), U⁴), ((U², U³), U⁴), and ((U³), U⁴)).

Continuing with FIG. 2, in Block 211, an AI model is trained to produce a predicted set of flow variables at a given timestep given one or more prior sets of flow variables according to the configuration of the AI model, where the AI model is trained using the set of training data constructed in Block 209. More information regarding the AI model and how it may be trained is provided later in the instant disclosure. Once trained, the AI model is considered developed and is ready for use. As such, for subsequent timesteps, and as depicted in Block 213, the AI model is used to determine a predicted set of flow variables given one or more prior sets of flow variables, the one or more prior sets of flow variables each previously determined using the iterative solver at a prior timestep. For example, in one or more embodiments, to solve for the set of flow variables at a timestep (t+1) for which the AI model has already been developed or is otherwise available, the AI model receives the previously determined M sets of flow variables (where M is a predefined number and M≥1) listed here as an array [U^{t+1-M}, . . . , U^{t}] and returns a predicted set of flow variables, U*, at timestep (t+1), U*^{(t+1)}. Then, U*^{(t+1)} is provided as the set of initial flow variables to the iterative solver to determined the set of flow variables at timestep (t+1), Uₜ₊₁. That is, for the iterative solver, U^{k=0, t+1}=U*^{(t+1)}. This process is described in Block 215, where the iterative solver is applied to the set of equations to determine the set of flow variables at the timestep, the iterative solver initialized with the predicted set of flow variables (i.e., predicted by the AI model in Block 213) at the timestep.

Generally, once the AI model is developed, for any given timestep the flowchart of FIG. 2 can proceed from Block 203 to Block 213. In one or more embodiments, the AI model is developed according to the steps depicted in FIG. 2 on a first multiphase fluid flow conveyed by a first pipe and then made available for immediate use to accelerate the modeling of a second multiphase flow conveyed by a second pipe. Further, in one or more embodiments, while modeling and determining the set of flow variables over timesteps using the AI model to provide a set of initial flow variables for each timestep, the AI model may be periodically retrained using a newly constructed training dataset including the sets of flow variables determined at timesteps since the last training (or re-training) of the AI model. In one or more embodiments, the AI model is re-trained according to a pre-defined periodicity such as every R number of timesteps, where R≥1. Further, in some instances, the set of training data constructed for re-training may only consist of the sets of determined flow variables since the last instance the AI model was trained (or re-trained) such that the process may be described as tuning the AI model or as a continuous learning AI model. In one or more embodiments, the AI model is re-trained upon determining that usage of the set of predicted flow variables at a given time step, when used as the set of initial flow variables by the iterative solver, did not reduce the number of iterations required by the iterative solver to reach convergence. In one or more embodiments, this determination is made by periodically initializing the iterative solver with a set of initial flow variables not determined using the AI model and comparing the number of iterations required to converge at this timestep with the number of iterations required to converge at an adjacent timestep where the iterative solver was initialized with a set of initial flow variables predicted using the AI model.

In one or more embodiments, the AI model used in Block 211 includes a time series predictor model. Time series predictor models have in common predicting a value of a time series at a timestep from the known values of the time series at one or more prior timesteps. Examples of time series predictor models that may be used in Block 211 include autoregressive models, moving average models, and a combination known as an autoregressive integrated moving average (ARIMA) model. An ARIMA model may include an autoregressive component that captures the relationship between the value of a time series at a timestep and the values of the times series at one or more prior timesteps. An ARIMA model may further include computing the difference between the value of the time series at a timestep and the value of the time series at a previous timestep and finally, further include a moving average component, that captures the relationship between the value of a time series at a timestep and the values of residual errors at prior timesteps, a residual error being defined as the differences between the exact values of the time series and the predicted values of the time series that are being computed by the ARIMA model. In one or more embodiments, the artificial intelligence model in Block 211 includes a neural network (NN) predictor, also referred to as a deep learning model. Examples of neural networks that may be used to predict the set of flow variables at a posterior timestep in Block 211 include convolutional neural network (CNN), recurrent neural networks (RNN), long-short-term memory (LSTM) models, fully connected (i.e., dense) networks, or a combination thereof. Generally, a NN may be set up as a times series predictor by using values of the time series at some timesteps as input and returning a value of the time series as a posterior timestep as output.

Herein, an iterative solver is defined as an algorithm that, given an initial value, z₀, produces a sequence intended to converge to a solution to an equation. The production of each term of the sequence is called an iteration of the iterative solver. In some embodiments, a number of iterations performed is limited by a predefined number, known as the maximum number of iterations, where the iterative solve may terminate at an iteration before reaching the maximum number of iterations by satisfying a convergence criterions (e.g., noting that the a change in determined values between iterations is vanishingly small or less than a predefined threshold). If a converge criterion is met, the iterative solver is said to have converged. In some instances, an iterative solver that reaches its maximum number of limitations may also be said to have converged, although it may be more appropriate to define this situation as reaching a maximum number of iterations termination criterion. An example of an iterative solver that may be used in Block 215 of FIG. 2 is a Newton method, also known as a Newton-Raphson method. Generally, the Newton method intends to find a solution z* to an equation F(z*)=0, where F is a differentiable function and represents a numerical scheme that discretizes the set of equations, as the limit as i tends to infinity of a sequence, zᵢ, where z₀ is a selected initial value, and the other terms are obtained recursively as:

$${𝓏}_{i + 1} = {𝓏}_{i} - {[ {F}^{′} ( {𝓏}_{i} ) ]}^{- 1} F ( {𝓏}_{i} ) for i > 0. \qquad EQ 14$$

In equation EQ 14, the linear application F′(zᵢ) is the derivative of F at point zᵢ and [F′(zᵢ)]⁻¹ is the inverse of the derivative of F at point zᵢ. In one or more embodiments, denoting [symbol] as the set of real numbers, z*∈ [symbol] ^{L} and the elements zᵢ∈ [symbol] ^{L} are L-dimensional vectors of real numbers, F: [symbol] ^{L}→ [symbol] ^{Q} is a Q-dimensional vector-valued function and then F′(zᵢ) is a linear application from [symbol] ^{L} to [symbol] ^{Q}, where L and Q are two positive integers. An example of a convergence criterion is defined by stopping the iterations of equation EQ 14 at an iteration I such that a norm of F(z_{I}) becomes smaller that a predefined number ε. The vector z_{I} is then said to be an approximation of the solution z*. In one or more embodiments, when an AI model is not yet developed (e.g., in Block 207), z*, or its approximation z_{I}, is used as the set of initial flow variables used by the iterative solver at a posterior timestep. Variations of the Newton method in equation EQ 14 exist, some of which are named as “pseudo-Newton” methods. It is noted that the iterative solver in equation EQ 14 and any of its variations is given only as an example and should not be considered limiting. Other iterative solvers in embodiments of the invention without departing from the scope of this disclosure.

Non-linear solvers, including the Newton method, may be sensitive to the choice of the initial value, z₀, of the iterative process, in the sense that the fact that the iterative solver converges or not, and, in case iterative solver converges, the number of iterations necessary for the iterative solver to converge, also known as a rate of convergence of the iterative solver, may depend on the choice of the initial value, z₀. In one or more embodiments, an iterative solver may never converge for a specific value of z₀. In that regard, intentionally choosing the initial value such that the iterative solver converges, or such that the number of iterations necessary to converge is as small as possible may be called “accelerating” the numerical solution to the equations from Block 203.

In one or more embodiments, the AI model is represented as a function H parameterized by a set of parameters α that receiving as an input a sequence V^{t+1} of M sets of flow variables immediately prior to a given timestep (t+1) (i.e., V^{t+1}=[U^{t-M+1}, . . . , U^{t}]). In one or more embodiments training the artificial intelligence model in Block 211 is done by selecting a certain norm, denoted by ∥·∥, and computing the set parameters α such that the fitting error Σ_{s∈{TD}|}∥H(V^{s};α)−U^{s+1}∥ is a minimum (at least locally), where {TD} is a set of timestep indices over which training data (TD) is available (in other words, a constructed set of training data is indexed by {TD}). The resulting function H (V^{t+1};α), with the computed set of parameters α, is the trained AI model.

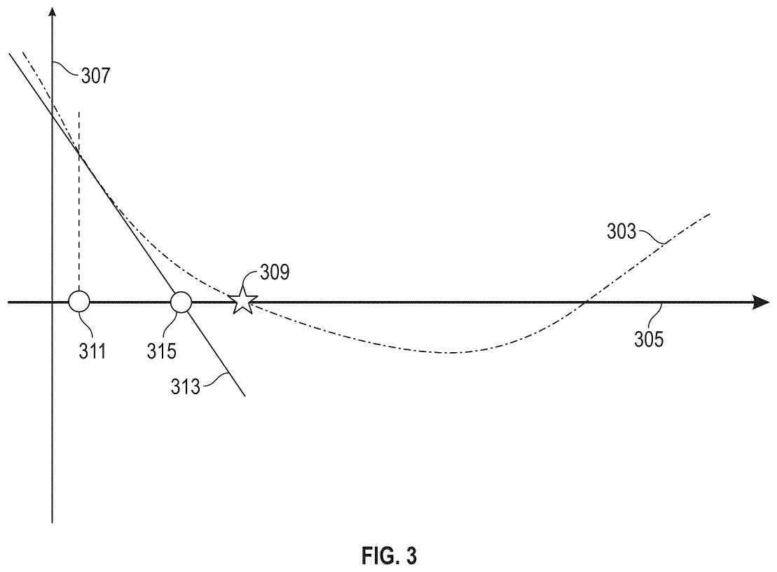

FIG. 3 depicts a special case of the Newton method from equation EQ 14, in which the zᵢ, the F(zᵢ), for all i, and any solution z* to the equation F(z*)=0 are one-dimensional. A curve (303) is the graph of the function F, plotting points (z,F(z)), in which z is measured on the abscissa axis (305) and F(z) is measured on the ordinate axis (307). The curve (303) crosses the abscissa axis (305) at a point (309). The abscissa of the point (309), denoted as z*, is a solution to the equation F(z*)=0. Given a point (311) with an abscissa of zᵢ, the derivative F′(zᵢ) in equation EQ 14 is the slope of a tangent (313) to the curve (303) at point (zᵢ,F(zᵢ)), and the next element in the sequence, zᵢ₊₁, in equation EQ 14, is the abscissa of a point (315) that intersects the tangent (313) and the abscissa axis (305). In this specific example, it is noted that the distance between the abscissa of the point (315) and the abscissa of the point (309) is less than the distance between the abscissa of the point (311) and the abscissa of the point (309), meaning that the element zᵢ₊₁ is closer to the solution z* to the equation F(z*)=0 then is zᵢ. This illustrates the fact that the sequence {zᵢ, i∈ [symbol] }, defined by the Newton method in equation EQ 14, is intended to converge toward the solution z* as i tends to infinity.

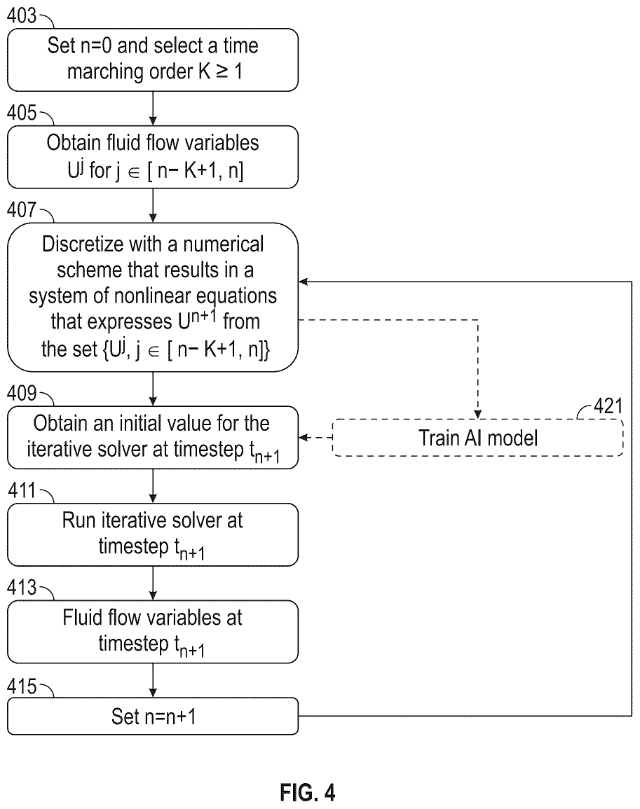

In accordance with one or more embodiments, FIG. 4 depicts an example of a numerical method for solving the multiphase fluid flow model according to the processes depicted in FIG. 2. In this example, a time interval is discretized into a sequence of distinct timesteps, tₙ, for a sequence of consecutive integers n, such that t₀=0, and tₙ₋₁<tₙ, for all n. Then, denoting U as the set of flow variables in a set of equations, a set of flow variables at a timestep tₙ is denoted as Uⁿ. In Step 403, n is set to 0 and an integer, K≥1, called a time marching order, is selected, that will be used as the number timesteps at which the flow variables are used in order to produce the flow variables at the next time step. In Step 405, the fluid flow variables U^{j} are obtained at timesteps tⱼ, for j∈[1−K,0]. The fluid flow variables U^{j}, for j∈[1−K,0] are called initial conditions. In one or more embodiments, the initial conditions U^{j}, for j∈[1−K,0], are obtained by measuring the fluid flow variables at one or more discrete, selected locations in the pipe, and extrapolating the measured values to each location in the pipe.

In Step 407, the fluid flow model is discretized with a numerical scheme. In one or more embodiments, the fluid flow model includes a time derivative. In one or more embodiments, the discretization of the time derivative is a one-timestep marching discretization, meaning that the discretization of the time derivative at time ty only involves Uⁿ⁺¹ and Uⁿ. An example of a one-timestep marching discretization is a Euler discretization method, in which

$$\frac{\partial U}{\partial t} ( {t}_{n} )$$

is discretized as

$$\frac{{U}^{n + 1} - {U}^{n}}{{t}_{n + 1} - {t}_{n}} .$$

Other examples of time discretization methods involve multi-timestep marching, such as Runge-Kutta methods. Generally, in a K timestep marching discretization, a time derivative is discretized using a formula involving Uⁿ⁺¹, and the K values of U^{j} in the set {U^{j}, j∈[n−K+1,n]}.

In one or more embodiments, the fluid flow model includes a spatial differential operator, and the discretization in Step 407 involves a spatial discretization. Examples of a spatial discretization include a finite difference method, a finite element method and a finite volume method. For each of these methods, it is assumed, in accordance with one or more embodiments, that the spatial domain occupied by the pipe is discretized by a grid of/discrete points in the pipe, xᵢ, for a sequence of consecutive integers i∈[0,I], for a given integer I≥1. In one or more embodiments, the grid is not uniform (i.e., an irregular grid). A finite difference method discretizes the spatial differential operator by replacing the spatial derivatives with discrete differences between nearby points on the grid. In some examples of finite element methods, a collection of continuous functions φᵢ, said basis functions, are defined, for each grid point xᵢ, for i∈[0,I], such that φᵢ(xᵢ)=1 and such that φⱼ(xᵢ)=0 for every j≠ᵢ. The flow variables Uⁿ are written as a linear combination of the functions φᵢ. Then, the differential operator is applied to the function Uⁿ.

In some examples of finite volume methods, a volume ωᵢ is defined around each grid point xᵢ, such that the volumes ωᵢ, for i∈[0,I], form a partition of the pipe. Then, the differential operator in each volume ωᵢ is replaced with a flux at the boundary of ωᵢ, and a discretization of the flux at the boundary of ωᵢ is used instead of a discretization of the differential operator in ωᵢ. It is noted that the examples given herein are given as examples only and should not be considered limiting. Other spatial discretization methods may be used without deviating from the scope of this disclosure. For instance, some finite element or finite volumes methods are built differently from their present description. Furthermore, other classes of spatial discretization methods exist, such as spectral methods. It is also noted that the grid points xᵢ may vary at each time step tₙ. In one or more embodiments, a meshless method may be used in Step 407, that does not require discretizing the pipe into a set of grid points. Examples of meshless methods include smooth particle hydrodynamics and meshless local Petrov-Galerkin methods.

In one or more embodiments, it follows that the flow variables U^{u}, for each n, are represented by a vector of real numbers, and that the numerical scheme in Step 407 may be written as:

$${U}^{n + 1} + G ( {U}^{n + 1} ) = H ( \{ {U}^{j} , j ∈ [ n - K + 1 , n ] \} ) , \qquad EQ 15$$

where G and H are two vector-valued functions. In equation EQ 15, the flow variables U^{j} are assumed to be known for j∈[n−K+1,n], while Uⁿ⁺¹, representing the flow variables at timestep tₙ₊₁, is to be computed. In the special scenario where G≡0, the numerical scheme in equation EQ 15 is said to be explicit, and Uⁿ⁺¹ can be computed directly, without solving any equation, as the right-hand side of equation EQ 15, that only includes the known value U^{j} for j∈[n−K+1,n]. In one or more embodiments, explicit numerical schemes have stability properties under a condition, such as a Courant-Friedrichs-Lewy (CFL) condition, that restricts the maximum timestep length, i.e., the maximum difference Δtₙ₊₁=tₙ₊₁−tₙ to be smaller than a certain threshold, the threshold depending on the minimum distance between two grid points discretizing the pipe and the velocities of each phase of the fluid. This may result in having to iterate the numerical scheme in equation EQ 15 a large number of times in order for a timestep ty to reach a desired value. In the general scenario where G≠0, the numerical scheme in equation EQ 15 is said to be implicit, and determining Uⁿ⁺¹ requires solving equation EQ 15. In one or more embodiments, implicit numerical schemes have unconditional stability properties and no condition on the differences Δtₙ₊₁ is necessary. In the general scope of this disclosure, the function G in equation EQ 15 is assumed to be non-linear, and therefore, determining Uⁿ⁺¹ using the numerical scheme in equation EQ 15 requires solving a system of non-linear equations. In one or more embodiments, the fact the function G in equation EQ 15 is non-linear results from the equations modeling the fluid flow in Block 203 in FIG. B being non-linear, such as the drift flux system of equations EQ1-EQ13.

In Step 409, an initial value is determined for the initial solver to be run in Step 411 for solving the non-linear equations from Step 407. The iterative solver is run in Step 411, that determines the value of the flow variables at timestep tₙ₊₁, namely, Uⁿ⁺¹. In Step 415, n is incremented by 1, and Steps 407, 409, 411 and 413 are re-iterated using the new, incremented value for n.

Going back to Step 409, obtaining an initial value for the iterative solver can be done in two ways, depending on the iteration number n. Given an integer A≥1, some first few temporal instances (i.e., timesteps) of the method in FIG. 4 are defined as the set of integers n such that n≤A, and later instances are defined as the set of integers n such that n>A. For the first few instances of the method in FIG. 4, that is, when n≤A, the initial value in Step 409 is set to Uⁿ, in accordance with one or more embodiments. That is, in these embodiments, for n≤A the initial value obtained at a given timestep is simply the set of flow variables from the previous immediate timestep. For the later instances of the method in FIG. 4, that is, when n>A, the initial value is obtain from a trained AI model that operates on the flow variables from one or more previous timesteps. As such, FIG. 4 depicts the training of the AI model in Step 421. The AI model is trained using a training dataset from, at least some of, the fluid flow variables that have previously been determined with the iterative method applied to the numerical scheme, i.e., {U^{j} for j=1, . . . ,n}. In one or more embodiments, the training of the AI model is done as previously discussed. For instance, selecting a fixed integer M such that 1<M<n, and two nonnegative integers n₁ and n₂ such that 0n₁+M≤n₂≤n, a training dataset may be constructed as a set of n₂−n₁−M+1 (input,ouput) pairs, each pair being indexed by an integer s such that 1≤s≤n₂−n₁−M+1, in which an input is the sequence V^{s}={U^{j},j∈[s+n₁−1,s+n₁+M−2]}, of length M, and the output is U^{s+n}^{₁}^{+M-1}. For example, if n=10 and the numbers M=3, n₁=4 and n₂=9 are selected, the training dataset defined herein contains 3 (input,output) pairs, each input being of length 3: ({U⁴, U⁵, U⁶}, U⁷), ({U⁵, U⁶, U⁷}, U⁸) and ({U⁶, U⁷, U⁸}, U⁹). In another example, if n=10 and the numbers M=1, n₁=4 and n₂=9 are selected, the training dataset defined herein contains 5 (input,output) pairs, each input being of length 1: ({U⁴}, U⁵), ({U⁵}, U⁶), ({U⁶}, U⁷), ({U⁷}, U⁸) and ({U⁸}, U⁹). That is, in contrast to the example training dataset previously illustrated in Table I, the use of the integers n₁ and n₂ allows for a more general case where a set of training data may be constructed for a subset of prior timesteps. If n₁=0 and n₂=n are selected, the training dataset uses all of the available, computed flow variables {U^{j}, j∈[1,n]} (as depicted in the example of Table I). Generally, using M>1 captures some of the dynamics of the sequence {Uⁿ}, as opposed to using M=1, which only captures a snapshot of the sequence {Uⁿ}. In one or more embodiments, training the AI model in Step 421 is done by selecting a certain norm, denoted by ∥·∥, and computing the set parameters α suc that the fitting error

$${\sum }_{s = 1}^{s = {J}_{2} - {J}_{1} - M + 1} ‖ H ( {V}^{s} ; α ) - {U}^{s + {n}_{1} + M - 1} ‖$$

is minimum, where the AI model is represented as the function H parameterized by a set of parameters, α, and s represents an index over the a set of training data as described above. The resulting function H(α,V), with the computed set of parameters α, is the trained AI model.

In one or more embodiments, the iterative solver, at a timestep (n+1), converges in less iterations using the output to the AI model as an initial value than using Uⁿ as an initial value, according to a convergence criterion. As such, using the AI model to compute the initial value of the iterative solver is referred to herein as “accelerating” the convergence of the numerical solution to the multiphase fluid flow model. The training of the model in Step 421 may be performed only once, or multiple times, where any training step occurs only when n>A. That is, the iterative method is used to solve the set of equations for the flow variables for at least A timesteps in order to form a training dataset of sufficient size to train the AI model. If the training is performed only once, at a timestep t_{n*}, the artificial intelligence initialization of the iterative solver for all subsequent timesteps, tₙ>t_{n*}, relies on some values U^{j}, for j≤n*. As such, in one or more embodiments, the number of iterations necessary for the convergence of the iterative solver in Step 411 may increase as n increases, meaning that the efficiency of intended acceleration of the convergence of the iterative solver is reduced as n increases. In one or more embodiments, the training of the AI model in Step 421 is re-done every time the number of iterations necessary for the convergence of the iterative solver in Step 411 is greater than an accelerated max iterations threshold. That is, in this embodiment, if when using an initial value for the iterative solver determined using the AI model, the iterative solver requires more iterations than the accelerated max iterations threshold, the AI model is re-trained. More generally, in some embodiments, re-training is performed when the iterative solver exceeds the accelerated max iterations threshold X times since the last instance the AI model was trained, where X is an integer such that X≥1. In one or more embodiments, re-training the AI model makes use of information from the AI model resulting from a previous training of the AI model. The process of training an AI model using information from an existing trained model is known as transfer learning.

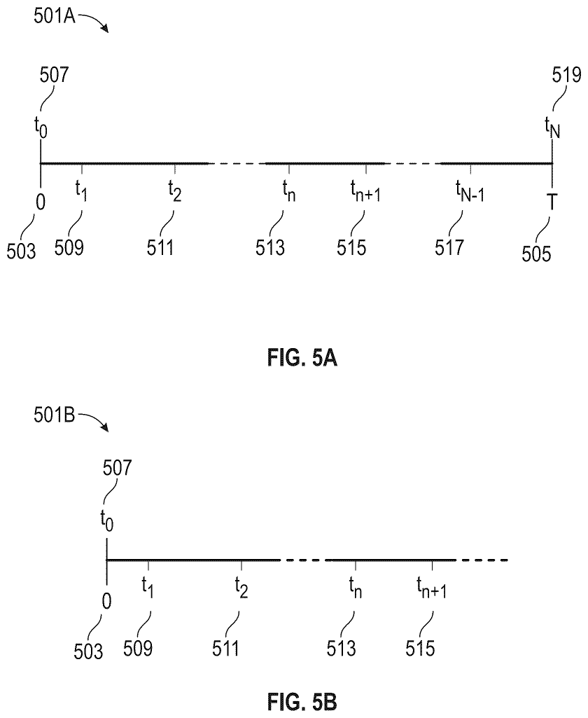

FIG. 5A and FIG. 5B depict examples of discretization of a time interval. In FIG. 5A, a finite time interval [0,T] (501A) is discretized into a sequence of distinct timesteps, tₙ, for a sequence of consecutive integers n∈[0,N], for a given integer N≥1, such that t₀=0 (503), T_{N}=T (505), and tₙ₋₁<tₙ, for all n∈[1,N]. In this specific example, the discretization includes at least 7 points, namely, t₀ (507), t₁ (509), t₂ (511), tₙ (513), for a certain integer n, tₙ₊₁ (515), t_{N-1} (517) and t_{N} (519). In FIG. 5B, an infinite time interval [0, +∞) (501B) is discretized into a sequence of distinct timesteps, tₙ, for a sequence of consecutive integers n≥1, such that t₀=0 (503), and tₙ₋₁<tₙ, for all n≥1. In this specific example, the discretization includes at least 5 points, namely, t₀ (507), t₁ (509), t₂ (511), tₙ (513), for a certain integer n, and tₙ₊₁ (515).

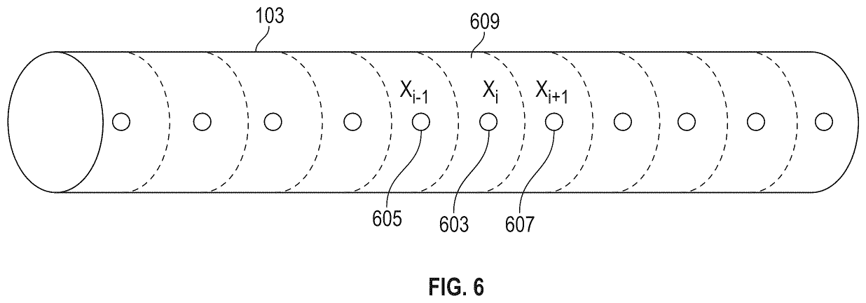

FIG. 6 depicts an example of a discretization of the pipe (103) into grid points, indexed by an integer i. The grid point xᵢ (603) is surrounded by the points xᵢ₋₁ (605) and xᵢ₊₁ (607). In one or more embodiments, such spatial discretization is used in the construction of numerical methods, such as finite difference methods, finite element methods and finite volume methods. A volume can be constructed around each grid point, such as a volume (609) constructed around the grid point xᵢ (603), such that the set of all volumes constructed around the grid points form a partition of the pipe (103).

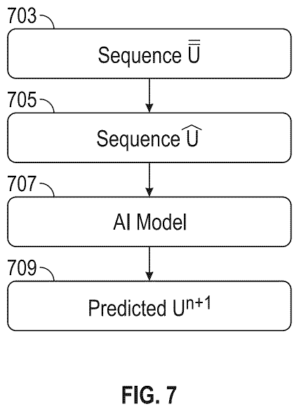

FIG. 7 depicts an overview of the AI model that is used to predict an initial value for an iterative solver (e.g., in Block 213 of FIG. 2), in accordance with one or more embodiments. In a similar fashion as in FIG. 5A and FIG. 5B, distinct positive numbers tₙ discretize a time interval and Uⁿ denotes the set of flow variables at time tₙ. At a given timestep tₙ with n≥1, a sequence of flow variables {U^{j}, j≤n} has been determined. As an example, the sequence of flow variables {U^{j}, j≤n} (703) may be obtained by using a numerical method, such as the one described in FIG. 4. Assuming that the AI model in Block 213, represented by the AI model (707) in FIG. 7, has been trained to receive a number M of sets of flow variables at corresponding to the M timesteps prior to some timestep (n+1) as input, for a certain integer M such that 1≤M≤n, a sequence Û of M elements (i.e., Û=[U^{n+1-M}, . . . ,Uⁿ]) (705) is determined from the sequence of all known sets of flow variables, U̅ (i.e., U̅=[U⁰, . . . , U^{N}] (703), to serve as input for the AI model (707). In one or more embodiments, the AI model (707) has been trained to receive the sequence Û storing the M prior sets of flow variables, contiguous, and immediately proceeding a timestep tₙ₊₁ and predict a set of the flow variables at time tₙ₊₁, Uⁿ⁺¹ (i.e., a set of predicted flow variables Uⁿ⁺¹ (709)). In some embodiments, the sequence Û might undergo a pre-processing step. Examples of pre-processing actions that may be performed on the sequence Û include, but are not limited to, a normalization of the elements of the sequence, a compression, such as a compression from 64-bit coded real numbers to 32-bit encoded real numbers, a mathematical transformation, such as a Fourier transformation, and a re-sampling of the elements of the sequence. If the sequence Û is obtained by a numerical method involving grid points such as a finite element method, re-sampling may include decimating the values of the terms of the sequence to a coarser grid after applying a spatial anti-alias filter. Decimating data may result in a faster computation time of any artificial intelligence model applied to that data. In one or more embodiments, the pre-processing of each element in the sequence Û is done independently from the other elements. In such a scenario, a set of flow variables Uⁿ may be pre-processed, and the pre-processed value may be stored at each iteration n. At each iteration n, the set of flow variables Uⁿ is then the only term that needs to be pre-processed in the sequence {U^{j},n+1−M≤j≤n}, since all the terms {U^{j},n+1−M≤j<n} have been pre-processed and their pre-processed values have been stored in previous iterations. In one or more embodiments, pre-processing makes also use of AI. The AI model (707), using the sequence (705) as input, returns the set of predicted flow variables Uⁿ⁺¹ (709) as output, that is used as an initial value of the iterative solver at time step tₙ. As discussed in the description of FIG. 2, the AI model (707) can be of various types, including, but not limited to ARIMA models and neural networks (NN).

Throughout this disclosure, artificial intelligence (AI) is used to predict an initial value to an iterative solver. AI, broadly defined, is the extraction of patterns and insights from data. The phrases “artificial intelligence”, “machine learning”, “deep learning”, and “pattern recognition” are often convoluted, interchanged, and used synonymously throughout the literature. This ambiguity arises because the field of “extracting patterns and insights from data” was developed simultaneously and disjointedly among a number of classical arts like mathematics, statistics, and computer science. For consistency, the term artificial intelligence (AI) is adopted herein. However, one skilled in the art will recognize that the concepts and methods detailed hereafter are not limited by this choice of nomenclature.

AI model types may include, but are not limited to, generalized linear models, Bayesian regression, random forests, and deep models such as neural networks, convolutional neural networks, and recurrent neural networks. AI model types, whether they are considered deep or not, are usually associated with additional “hyperparameters” which further describe the model. For example, hyperparameters providing further detail about a neural network may include, but are not limited to, the number of layers in the neural network, choice of activation functions, inclusion of batch normalization layers, and regularization strength. Commonly, in the literature, the selection of hyperparameters surrounding an AI model is referred to as selecting the model “architecture.” Once an AI model type and hyperparameters have been selected, the AI model is trained to perform a task.

In accordance with one or more embodiments, the previously discussed AI model (707) is, or make use of, a neural network (NN) such as a convolutional neural network (CNN) or a recurrent neural network (RNN). A cursory introduction to a NN is provided herein. However, it is noted that many variations of a NN exist. Therefore, one with ordinary skill in the art will recognize that any variation of the NN (or any other AI model) may be employed without departing from the scope of this disclosure. Further, it is emphasized that the following discussions of a NN is a basic summary and should not be considered limiting.

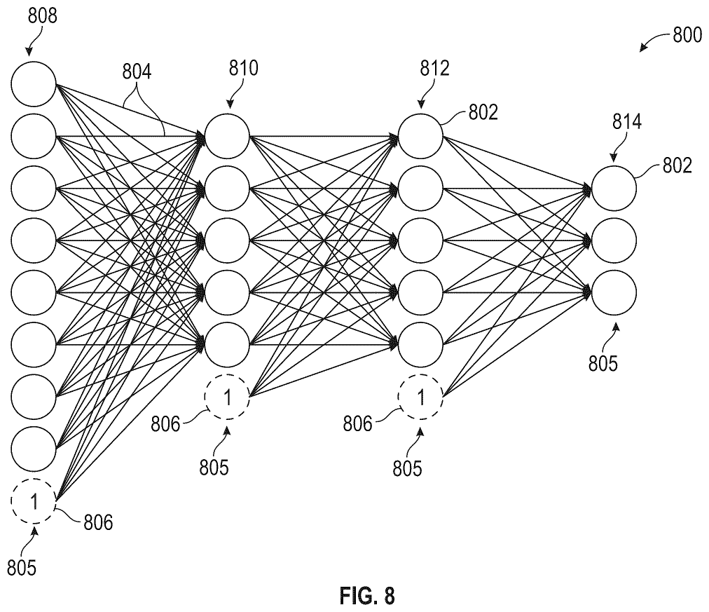

A diagram of a neural network is shown in FIG. 8. At a high level, a neural network (800) may be graphically depicted as being composed of nodes (802), where here any circle represents a node, and edges (804), shown here as directed lines. The nodes (802) may be grouped to form layers (805). FIG. 8 displays four layers (808, 810, 812, 814) of nodes (802) where the nodes (802) are grouped into columns, however, the grouping need not be as shown in FIG. 8. The edges (804) connect the nodes (802). Edges (804) may connect, or not connect, to any node(s) (802) regardless of which layer (805) the node(s) (802) is in. That is, the nodes (802) may be sparsely and residually connected. A neural network (800) will have at least two layers (805), where the first layer (808) is considered the “input layer” and the last layer (814) is the “output layer.” Any intermediate layer (810, 812) is usually described as a “hidden layer.” A neural network (800) may have zero or more hidden layers (810, 812) and a neural network (800) with at least one hidden layer (810, 812) may be described as a “deep” neural network or as a “deep learning method.” In general, a neural network (800) may have more than one node (802) in the output layer (814). In this case the neural network (800) may be referred to as a “multi-target” or “multi-output” network.

Nodes (802) and edges (804) carry additional associations. Namely, every edge is associated with a numerical value. The edge numerical values, or even the edges (804) themselves, are often referred to as “weights” or “parameters.” While training a neural network (800), numerical values are assigned to each edge (804). Additionally, every node (802) is associated with a numerical variable and an activation function. Activation functions are not limited to any functional class, but traditionally follow the form

$$A = f ( {\sum }_{i ∈ ( incoming )} [ {( node value )}_{i} {( edge value )}_{i} ] ) , \qquad EQ 16$$

where i is an index that spans the set of “incoming” nodes (802) and edges (804) and ƒ is a user-defined function. Incoming nodes (802) are those that, when the neural network (800) is viewed or depicted as a directed graph (as in FIG. 8), have directed arrows that point to the node (802) where the numerical value is being computed. Some functions for ƒ may include the linear function ƒ(x)=x, sigmoid function

$$f ( x ) = \frac{1}{1 + {e}^{- x}} ,$$

and rectified linear unit function ƒ(x)=max(0,x), however, many additional functions are commonly employed. Every node (802) in a neural network (800) may have a different associated activation function. Often, as a shorthand, activation functions are described by the function ƒ by which it is composed. That is, an activation function composed of a linear function ƒ may simply be referred to as a linear activation function without undue ambiguity.

When the neural network (800) receives an input, the input is propagated through the network according to the activation functions and incoming node (802) values and edge (804) values to compute a value for each node (802). That is, the numerical value for each node (802) may change for each received input. Occasionally, nodes (802) are assigned fixed numerical values, such as the value of 1, that are not affected by the input or altered according to edge (804) values and activation functions. Fixed nodes (802) are often referred to as “biases” or “bias nodes” (806), displayed in FIG. 8 with a dashed circle.

In some implementations, the neural network (800) may contain specialized layers (805), such as a normalization layer, or additional connection procedures, like concatenation. One skilled in the art will appreciate that these alterations do not exceed the scope of this disclosure.

As noted, the training procedure for the neural network (800) comprises assigning values to the edges (804). To begin training the edges (804) are assigned initial values. These values may be assigned according to a prescribed distribution, assigned manually, or by some other assignment mechanism. Once edge (804) values have been initialized, the neural network (800) may act as a function, such that it may receive inputs and produce an output. As such, at least one input is propagated through the neural network (800) to produce an output. Training data is provided to the neural network (800). Generally, training data consists of pairs of inputs and associated targets. The targets represent the “ground truth,” or the otherwise desired output, upon processing the inputs. In the context of the instant disclosure, an input is a sequence of the flow variables at a defined number M of timesteps, for a predefined integer M≥1. As such, during training, the input is a sequence of the flow variables at a defined number M of timesteps, and its associated target is defined as the flow variables at a timestep that is posterior to those M timesteps. During training, the neural network (800) processes at least one input from the training data and produces at least one output. Each neural network (800) output is compared to its associated input data target. The comparison of the neural network (800) output to the target is typically performed by a so-called “loss function;” although other names for this comparison function such as “error function,” “misfit function,” and “cost function” are commonly employed. Many types of loss functions are available, such as the mean-squared-error function, however, the general characteristic of a loss function is that the loss function provides a numerical evaluation of the similarity between the neural network (800) output and the associated target. The loss function may also be constructed to impose additional constraints on the values assumed by the edges (804), for example, by adding a penalty term, which may be physics-based, or a regularization term. Generally, the goal of a training procedure is to alter the edge (804) values to promote similarity between the neural network (800) output and associated target over the training data. Thus, the loss function is used to guide changes made to the edge (804) values, typically through a process called “backpropagation.”

While a full review of the backpropagation process exceeds the scope of this disclosure, a brief summary is provided. Backpropagation consists of computing the gradient of the loss function over the edge (804) values. The gradient indicates the direction of change in the edge (804) values that results in the greatest change to the loss function. Because the gradient is local to the current edge (804) values, the edge (804) values are typically updated by a “step” in the direction indicated by the gradient. The step size is often referred to as the “learning rate” and need not remain fixed during the training process. Additionally, the step size and direction may be informed by previously seen edge (804) values or previously computed gradients. Such methods for determining the step direction are usually referred to as “momentum” based methods.

Once the edge (804) values have been updated, or altered from their initial values, through a backpropagation step, the neural network (800) will likely produce different outputs. Thus, the procedure of propagating at least one input through the neural network (800), comparing the neural network (800) output with the associated target with a loss function, computing the gradient of the loss function with respect to the edge (804) values, and updating the edge (804) values with a step guided by the gradient, is repeated until a termination criterion is reached. Common termination criteria are: reaching a fixed number of edge (804) updates, otherwise known as an iteration counter; a diminishing learning rate; noting no appreciable change in the loss function between iterations; reaching a specified performance metric as evaluated on the data or a separate hold-out data set. Once the termination criterion is satisfied, and the edge (804) values are no longer intended to be altered, the neural network (800) is said to be “trained.”

A structural grouping, or group, of weights is herein referred to as a “filter.” The number of weights in a filter is typically much less than the number of inputs. In one or more embodiments, the AI model (707) includes a convolutional neural network (CNN). The basic structure of a CNN is defined using the terminology established in the description of a NN. In a CNN, the filters can be thought as “sliding” over, or convolving with, the inputs to form an intermediate output or intermediate representation of the inputs which still possesses a structural relationship. Like unto the neural network (800), the intermediate outputs are often further processed with an activation function. Many filters may be applied to the inputs to form many intermediate representations. Additional filters may be formed to operate on the intermediate representations creating more intermediate representations. This process may be repeated as prescribed by a user. There is a “final” group of intermediate representations, wherein no more filters act on these intermediate representations. In some instances, the structural relationship of the final intermediate representations is ablated; a process known as “flattening.” The flattened representation may be passed to a neural network (800) to produce a final output. Note, that in this context, the neural network (800) is still considered part of the CNN. Like unto a neural network (800), a CNN is trained, after initialization of the filter weights, and the edge (804) values of the internal neural network (800), if present, with the backpropagation process in accordance with a loss function.

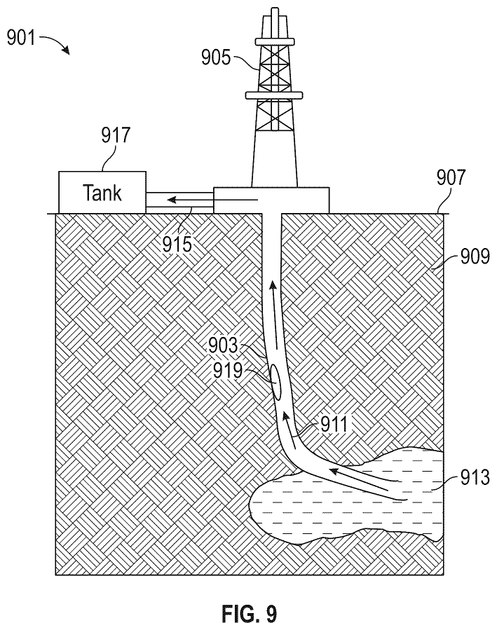

In accordance with one or more embodiments, a multiphase fluid, such a tri-phase fluid of water, oil, and gas is conveyed through wellbore of a hydrocarbon production well. FIG. 9 depicts a well (901) where a multiphase fluid containing hydrocarbons is extracted from hydrocarbon reservoir (913) located in the subsurface (909). The direction of flow (911) is from the reservoir (913) to the surface (907). In general, a hydrocarbon production well may be configured in a myriad of ways. Therefore, the well (901) is not intended to be limiting to any configuration. The well (901) is depicted as being on land. In other examples, the well (901) may be located offshore. The pumping of the hydrocarbons is made by a derrick (905) located on the surface (907). A line (915) connects the derrick (905) to a tank (917), in which the hydrocarbons are collected. A plurality of sensors (919), connected to the wellbore (903), is set up to measure fluid flow variables at one or more locations in the wellbore (9). Examples fluid flow variables that may be measured by the sensors include a density for each phase, a fluid velocity for each phase, a volume fraction of the total fluid volume for each phase, and bulk property measurements for the multiphase mixture, such as a bulk density, a bulk velocity, a pressure and a temperature. In one or more embodiments, the multiphase fluid flowing through the wellbore (903) is a tri-phase fluid composed of water, oil and gas.

Examples of sensors that may be included among the plurality of sensors (919) include a pressure sensor, a flow rate sensor, a temperature sensor and a gas concentration sensor. In FIG. 9, the sensors (919) are grouped together and located downhole, on the side of the wellbore (903). However, this example should not be considered limiting, and in other embodiments, the sensors (919) may be separated and located anywhere, downhole or at the surface, connected to the wellbore (903). In one or more embodiments, the plurality of sensors (919) include a multiphase flow meter (MPFM). An MPFM is a device that measures the rate at which oil, gas and water is flowing. That is, the MPFM may detect the instantaneous amount of gas, oil, and water flowing in the wellbore (903). As such, the MPFM may indicate additional quantities such as percent water cut (% WC) and the gas-to-oil ratio (GOR). In general, an MPFM cannot directly measure the flowrate of the individual phases in a fluid. Rather, an MPFM is a collection of sensors, transmitters, mechanical devices, flow conduits, and programmed relationships that are used to determine the individual phase flowrates. A MPFM may use a gamma densitometer to measure a bulk density of the multiphase fluid. A gamma densitometer emits a beam of photons from a nuclear source. Then, the emitted photons are attenuated by the multiphase fluid and the amount of attenuation is determined using a nuclear detector that measures the number of received photons. The amount of attenuation is greatly affected by the bulk density of the multiphase fluid. Further, because gas has a significantly lower density compared to water and oil, a gamma densitometer can be used to accurately determine the liquid (water and oil) and gas fractions of the multiphase fluid. An MPFM may further include a Venturi section that is used to measure mass flowrates. An MPFM may further include a capacitance sensor to determine the fraction of oil, water, and gas in the multiphase fluid.

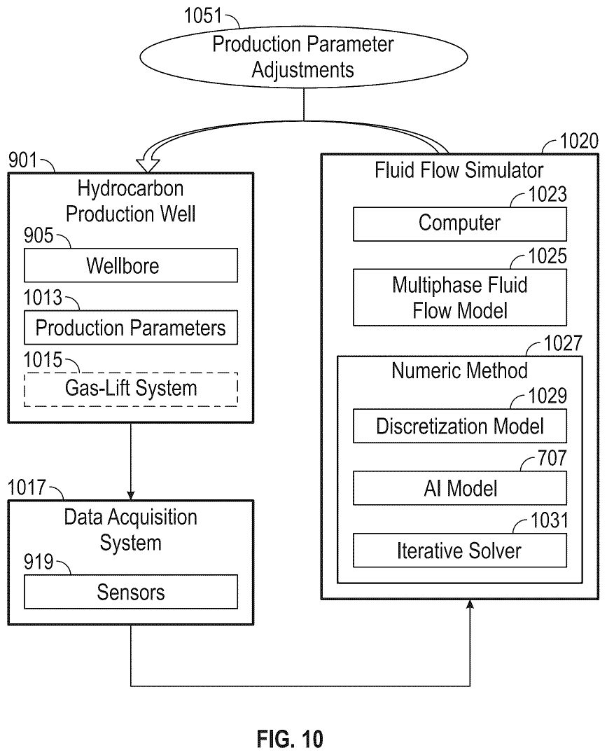

FIG. 10 depicts a system for applying the method from FIG. 2 to the hydrocarbon production well (901), such as the one described in FIG. 9, in accordance with one or more embodiments. The main components in the system in FIG. 10 are a hydrocarbon production well (901), a data acquisition system (1017) and a fluid flow simulator (1020). The hydrocarbon production well (901) includes the wellbore (903). The flow of the multiphase fluid through the wellbore (903) is controlled by a set of production parameters (1013). Examples of production parameters include a state of one or more choke valves that govern the flow rate, where the state may be binary, such as “open” or “closed,” or continuous-valued such that the value indicates a degree of openness (or closedness) of the choke valve. If the hydrocarbon production well (901) includes a gas-lift system (1015), another example of a flow parameter is the gas injection pressure of the gas that is injected into the wellbore to reduce the pressure of multiphase fluid. One with ordinary skill in the art will recognize that many additional production parameters exist for operating a well and that production parameters of the instant disclosure are not limited to the above examples. The data acquisition system (1017), connected to the hydrocarbon production well (901), includes the sensors (919) that measure the fluid flow variables at one or more locations of the wellbore (903), at certain times. These measurements of the fluid flow variables are received by the fluid flow simulator (1020).

The fluid flow simulator (1020) includes a multiphase fluid flow model (1025), modeling the multiphase fluid flow within the wellbore (903). Examples of a multiphase fluid flow model (1025) include the drift-flux model defined by equations EQ 1-EQ 13. The fluid flow simulator (1020) further includes a numerical method (1027), hosted and run on a computer (1023). An example of a numerical method that may be used as the numerical method (1027) is the Newton method, described with respect to FIG. 4. The fluid flow simulator (1020) is configured to receive fluid flow parameters acquired by the sensors (919) at one or more locations in the hydrocarbon production well (901), that may be used as initial or boundary conditions, or both, by the numerical method (1027). The numerical method (1027) includes a discretization model (1029), that discretizes the multiphase fluid flow model (1025) into equations, such as the numerical discretization scheme used in Step (407) of FIG. 4. The numerical method (1027) further includes the AI model (707), that predicts an initial value for an iterative solver (1031), in accordance with FIG. 7, Block 207 in FIG. 2 and Step 409 in FIG. 4. The iterative solver (1031) runs and outputs a solution to the equations produced by the discretization model (1029). In one or more embodiments, the numerical method (1027) iterates in a similar fashion to the method in FIG. 4 From the fluid flow variables measured at one or more discrete, selected locations in the wellbore (901) at some times, the fluid flow simulator (1020) produces modeled fluid flow variables at any location in the wellbore (903), at any sequence of timesteps. In accordance with the modeled fluid flow variables modeled at the sequence of timesteps, from the fluid flow simulator (1020), the production parameters (1013) may be adjusted through the production parameter adjustments action (1051). In one or more embodiments, adjusting the production parameters through the action (1051) includes closing and opening valves and chokes to regulate the flow rate of hydrocarbons from the hydrocarbon production well (901) to optimize the hydrocarbon production.

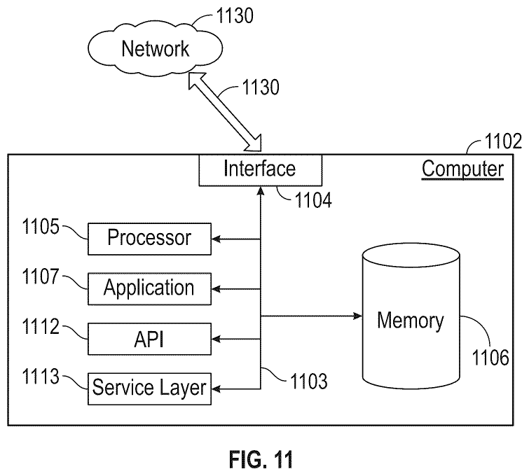

The computations mentioned in this disclosure may be performed by a computer, such as the computer (1023) in FIG. 10. In that regard, FIG. 11 depicts a block diagram of a computer (1102) used to provide computational functionalities associated with described algorithms, methods, functions, processes, flows, and procedures as described in this disclosure, according to one or more embodiments. The illustrated computer (1102) is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. In some implementations, one or more components of the computer (1102) may be configured to operate within environments, including cloud-computing-based, local, global, or other environments (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) from a client application (for example, executing on another computer (1102) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or another suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104) includes logic encoded in software or hardware (or a combination of software and hardware) and operable to communicate with the network (1130). More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure.

The computer (1102) also includes a memory (1106) that holds data for the computer (1102) or other components (or a combination of both) that can be connected to the network (1130). The memory may be a non-transitory computer readable medium. For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), wherein each computer (1102) communicates over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A method, comprising:
obtaining a set of equations comprising at least one equation, the set of equations modeling a flow of a multiphase fluid, wherein the flow is characterized by a set of flow variables;
determining, with an artificial intelligence model, a predicted set of flow variables at a timestep given one or more prior sets of flow variables each previously determined at an associated prior timestep; and
determining, with an iterative solver applied to the set of equations, the set of flow variables at the timestep, wherein the iterative solver is initialized with the predicted set of flow variables at the timestep.

2. The method of claim 1, further comprising:
determining the set of flow variables at N timesteps resulting in N sets of determined flow variables, where N is at least 1, with the iterative solver applied to the set of equations, wherein the iterative solver is initialized, at each of the N timesteps, with an initial set of flow variables;
constructing a set of training data based on, at least, the N sets of determined flow variables; and
training the artificial intelligence model to produce the predicted set of flow variables at the timestep, wherein the artificial intelligence model is trained using the set of training data.

3. The method of claim 1, further comprising:
adjusting a set of production parameters based on the set of flow variables at the timestep, wherein the flow is governed by the set of production parameters.

4. The method of claim 1, wherein the set of equations is temporally averaged Navier-Stokes equations with a set of flow-dependent closure terms.

5. The method of claim 4, wherein the set of equations is comprised by an isothermal compressible three-phase drift-flux model.

6. The method of claim 1, wherein the iterative solver is based on a Newton method.

7. The method of claim 2, further comprising:
making a determination that the iterative solver required more iterations to determine the set of flow variables at the timestep initialized with the predicted set of flow variables than required to determine the set of flow variables at the timestep initialized with a prior set of determined flow variables, and
based on the determination, constructing a new set of training data based on, at least, prior sets of determined flow variables and re-training the artificial intelligence model using the new set of training data.

8. The method of claim 1, wherein the artificial intelligence model is a long short-term memory network.

9. A system, comprising:
a pipe that conveys a flow of a multiphase fluid, the flow characterized by a set of flow variables;
a data acquisition system that collects a set of measured flow variables at one or more locations within the pipe, from a plurality of sensors disposed on the pipe; and
a computer comprising one or more computer processors, the computer communicatively connected to the data acquisition system and configured to:
receive a set of flow variables at a set of one or more timesteps,
obtain a set of equations comprising at least one equation, the set of equations modeling the flow of the multiphase fluid in the pipe,
determine, with an artificial intelligence model, a predicted set of flow variables at a timestep posterior to set of one or more timesteps, given the set of flow variables at the set of one or more timesteps; and
determine, with an iterative solver applied to the set of equations, the set of flow variables at the timestep, the iterative solver initialized with the predicted set of flow variables at the timestep and informed by the set of measured flow variables at one or more locations within the pipe.

10. The system of claim 9, wherein the computer is further configured to:
determine the set of flow variables at N timesteps resulting in N sets of determined flow variables, where N is at least 1, with the iterative solver applied to the set of equations, wherein the iterative solver is initialized, at each of the N timesteps, with an initial set of flow variables;
construct a set of training data based on, at least, the N sets of determined flow variables; and
train the artificial intelligence model to produce the predicted set of flow variables at the timestep, wherein the artificial intelligence model is trained using the set of training data.

11. The system of claim 9,
wherein the pipe is a wellbore of a hydrocarbon production well, and
wherein the plurality of sensors comprises a pressure sensor.

12. The system of claim 9, wherein the computer is further configured to:
adjust a set of production parameters based on the set of flow variables at the timestep, wherein the flow is governed by the set of production parameters.

13. The system of claim 9, wherein the set of equations is comprised by an isothermal compressible three-phase drift-flux model.

14. The system of claim 9, wherein the iterative solver is based on a Newton method.

15. The system of claim 10, wherein the computer is further configured to:
make a determination that the iterative solver required more iterations to determine the set of flow variables at the timestep initialized with the predicted set of flow variables than required to determine the set of flow variables at the timestep initialized with a prior set of determined flow variables, and
based on the determination, construct a new set of training data based on, at least, prior sets of determined flow variables and re-training the artificial intelligence model using the new set of training data.

16. A non-transitory computer-readable memory comprising computer-executable instructions stored thereon that, when executed on a processor, cause the processor to perform steps comprising:
obtaining a set of equations comprising at least one equation, the set of equations modeling a flow of a multiphase fluid, wherein the flow is characterized by a set of flow variables;
determining, with an artificial intelligence model, a predicted set of flow variables at a timestep given one or more prior sets of flow variables each previously determined at an associated prior timestep; and
determining, with an iterative solver applied to the set of equations, the set of flow variables at the timestep, the iterative solver initialized with the predicted set of flow variables at the timestep.

17. The non-transitory computer-readable memory of claim 16, the steps further comprising:
determining the set of flow variables at N timesteps resulting in N sets of determined flow variables, where N is at least 1, with the iterative solver applied to the set of equations, wherein the iterative solver is initialized, at each of the N timesteps, with an initial set of flow variables;
constructing a set of training data based on, at least, the N sets of determined flow variables; and
training the artificial intelligence model to produce the predicted set of flow variables at the timestep, wherein the artificial intelligence model is trained using the set of training data.

18. The non-transitory computer-readable memory of claim 16, the steps further comprising:
adjusting a set of production parameters based on the set of flow variables at the timestep, wherein the flow is governed by the set of production parameters.

19. The non-transitory computer-readable memory of claim 16, wherein the set of equations are comprised by an isothermal compressible three-phase drift-flux model.

20. The non-transitory computer-readable memory of claim 17, the steps further comprising:
making a determination that the iterative solver required more iterations to determine the set of flow variables at the timestep initialized with the predicted set of flow variables than required to determine the set of flow variables at the timestep initialized with a prior set of determined flow variables, and
based on the determination, constructing a new set of training data based on, at least, prior sets of determined flow variables and re-training the artificial intelligence model using the new set of training data.
